(19) United States
(12) Patent Application Publication
(10) Pub. No.: US 2026/0267796 A1
(43) Pub. Date: Sep. 10, 2026

(54) MANAGING OVER PROVISIONING SPACE AMONG PEER DATA STORAGE DEVICES

(71) Applicant: Sandisk Technologies, Inc., Milpitas, CA (US)

(72) Inventors: RAMANATHAN MUTHIAH, Bangalore (IN); ROHAN GOEL N, Bangalore (IN); DATTATREYA NAYAK, Bangalore (IN)

(73) Assignee: Sandisk Technologies, Inc., Milpitas, CA (US)

(21) Appl. No.: 19/071,975

(22) Filed: Mar. 6, 2025

(51) Int. Cl. G06F 12/02

(52) U.S. Cl. CPC G06F 12/0253

(57) ABSTRACT

A storage server may mitigate system performance degradation caused by garbage collection activities on one or more storage devices in the storage server. The storage server may include multiple storage devices, each of which may execute garbage collection activities to optimize memory usage. The storage server may also include a master storage device to monitor storage devices on the storage server, identify an overburdened storage device, and offload a garbage collection workload of the overburdened storage device to a second storage device. The second storage device is an over-provisioning agent for the overburdened storage device and an over-provisioning region on the second storage device may be used for the garbage collection workload of the overburdened storage device.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks and the storage device may store data in pages on blocks on the memory device. Data may only be erased at the block level and data may only be written to a block only after the block has been completely erased. As a result, a block may include a mix of valid and invalid/obsolete data, with the storage occupied by the obsolete data being considered wasted space. To remove obsolete data from a block without erasing the valid data stored on the block, a controller in the storage device may execute garbage collection. During garbage collection, the controller may move the valid data on a source block to a new location (i.e., a destination block) to allow the source block to be reclaimed and used for new data storage. Garbage collection consumes the internal bandwidth of the controller, possibly consuming processing resources that may otherwise be used for handling host requests. While garbage collection may be crucial for optimizing how the storage space is used, garbage collection may affect the performance and longevity of the storage device.

In addition to blocks that may be configured to store host and control data, the storage device may include an over-provisioning space/region with free blocks that may be used by the controller as a temporary workspace. The over-provisioning space may be accessed by the controller, and not the host, and may include only free blocks that may not be counted towards the user capacity of the storage device. The over-provisioning space may serve as an additional buffer for host writes and for garbage collection and other relocation operations, wherein when a garbage collection or a host write operation is in progress, the controller may use the free blocks in the over-provisioning space which may improve the performance of the storage device. For instance, the controller may buffer valid data in the over-provisioning space during relocation operations when other blocks that are configured to store host data are full. Configuring the storage device to include an over-provisioning space may increase the memory capacity of the storage device, which may be costly.

Emerging computing applications, such as those used for big data analytics and deep learning, may require highly optimized and balanced computing, networking, and storage resources. To meet the demands associated with such applications, a networked storage architecture may integrate multiple storage devices into a storage server. The integrated storage devices may be connected to the network via a smart network interface card. This architecture may ensure that data-intensive applications can operate seamlessly, handling vast amounts of data with the necessary speed and reliability. However, any drop in the performance of a storage device in this architecture may affect the performance of the overall storage network. Performing garbage collection on a storage device in this architecture may potentially slow down processing on the storage device and lead to longer latencies for data retrieval and/or processing. Therefore, garbage collection operations may have the potential to degrade both the performance of an individual storage device and, consequently, the overall performance of the storage network.

### SUMMARY OF THE INVENTION

In some implementations, a storage server may mitigate system performance degradation caused by garbage collection activities on one or more storage devices in the storage server. The storage server may include multiple storage devices, each of which may execute garbage collection activities to optimize memory usage. The storage server may also include a master storage device to monitor storage devices on the storage server, identify an overburdened storage device, and offload a garbage collection workload of the overburdened storage device to a second storage device. The second storage device is an over-provisioning agent for the overburdened storage device and an over-provisioning region on the second storage device may be used for the garbage collection workload of the overburdened storage device.

In some implementations, a method is provided on the storage device for mitigating system performance degradation caused by garbage collection activities on one or more storage devices in the storage server. The method includes monitoring storage devices on the storage server and identifying an overburdened storage device or a storage device where a free block count is less than a threshold. The method also includes offloading a garbage collection workload of the overburdened storage device to a second storage device, wherein the second storage device is an over-provisioning agent for the overburdened storage device and an over-provisioning region on the second storage device is used for the garbage collection workload of the overburdened storage device.

In some implementations, a storage device may a storage server may distribute garbage collection activities from user capacity blocks on a first storage device in a network of storage devices to user capacity blocks on a second storage device in the network. The storage server includes multiple storage devices, each of which may execute garbage collection activities to optimize memory usage. The storage server also includes a common volatile memory that is accessed by storage devices in the network. A master storage device in the storage service may monitor the storage devices, identify a first storage device as an overburdened storage device; select a second storage device is an over-provisioning agent, and trigger cross-storage device garbage collections. After cross-storage device garbage collections are triggered, the first storage device may obtain data from source blocks on the first storage device and place the data in the common volatile memory and the second storage device may copy the data from the common volatile memory to destination blocks on another storage device.

### BRIEF DESCRIPTION OF THE DRAWINGS

FIG. 1 is a schematic block diagram of an example system in accordance with some implementations.

FIG. 2 is a schematic block diagram of an example server that includes multiple storage devices wherein over-provisioning space among peer storage devices is managed in accordance with some implementations.

FIG. 3 is another schematic block diagram of an example server that includes multiple storage devices wherein over-provisioning space among peer storage devices is managed in accordance with some implementations.

FIG. 4 is an example flow diagram for using one of the storage devices in a network of storage devices as an over-provisioning agent in accordance with some implementations.

FIG. 5 is a schematic block diagram of an example system including a network of storage devices wherein garbage collection activities are distributed from a first storage device capacity blocks to another storage device capacity blocks in accordance with some implementations.

FIG. 6 is a diagram of an example environment in which systems and/or methods described herein are implemented.

FIG. 7 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

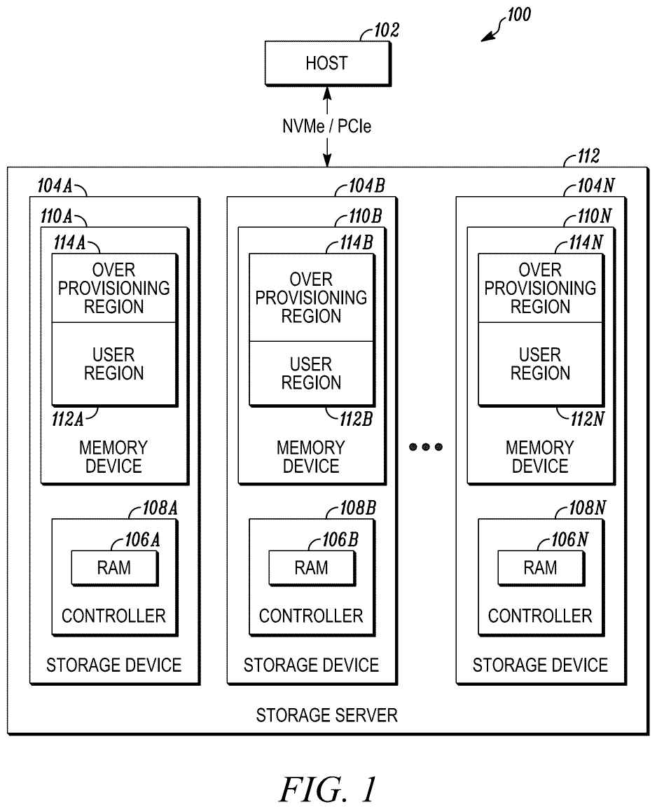

FIG. 1 is a schematic block diagram of an example system in accordance with some implementations. System 100 may include a host 102 and a storage server 112 including storage device 104a-104n (referred to herein as the storage device(s) 104). Host 102 and storage server 112 may be in the same physical location as components on a single computing device or on different computing devices that are communicatively coupled. Storage server 112 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage devices 104 may include random-access memory (RAM) 106a-106n (generally referred to herein as RAM(s) 106), controllers 108a-108n (generally referred to herein as controller(s) 108), and one or more storage components such as non-volatile memory devices 110a-110n (referred to herein as the memory device(s) 110). Storage device 104 may be, for example, a solid-state drive (SSD). RAM 106 may be, for example, static RAM (SRAM) or dynamic RAM (DRAM) that be used to temporarily store data on storage device 104.

Controllers 108 may interface with host 102 and process foreground operations including instructions transmitted from host 102. For example, controllers 108 may read data from and/or write to memory devices 110 based on instructions received from host 102. Controllers 108 may also execute background operations to manage resources on memory device 110. For example, controllers 108 may monitor memory devices 110 and may execute garbage collection and other relocation functions per internal relocation algorithms to refresh, recycle, and/or relocate the data on memory devices 110.

Memory devices 110 may be flash based. For example, memory devices 110 may be a NAND or NOR flash memory that may be used for storing host and control data over the operational life of memory devices 110. Memory devices 110 may include one or more dies connected to a memory bus including data lines and chip enable lines. The dies may be divided into blocks and data may be stored in the blocks in various formats, with the formats being defined by the number of bits that may be stored per memory cell. The blocks on memory devices 110 may be divided into user regions 112a-112n (referred to herein as user region(s) 112) where user data may be stored and over-provisioning regions 114a-114n (referred to herein as over-provisioning region(s) 114). Memory device 110 may be included in storage device 104 or may be otherwise communicatively coupled to storage device 104.

In a network of storage devices 104, as shown, for example, using storage server 112, an implementation may mitigate overall system performance degradation that may be caused by garbage collection activities on an individual storage device 104. Storage devices 104 may distribute or offload garbage collection workloads across multiple storage devices 104 on storage server 112. The implementation may leverage the concept that not all storage devices 104 may experience intensive host and/or garbage collection workloads simultaneously. As such, not all storage devices 104 may need the associated over-provisioning region 114 at the same time, such that at least one storage device 104 may provide its over-provisioning region 114 to another storage device 104 as a service. Garbage collection tasks may thus be redistributed from a heavily loaded storage device 104 (referred to herein as a first storage device 104) to another storage device 104 (referred to herein as a second storage device 104) with available resources or less intensive host and/or garbage collection workloads. By doing so, the workload may be balanced across the storage server 112, preventing any single storage device 104 from becoming a bottleneck due to excessive garbage collection activities.

In an implementation, one of the participating storage devices 104, for example, storage device 104n, may be a master storage device to drive the data transfer between storage devices 104. The master storage device may monitor the other storage devices 104 to identify an overloaded storage device. The master storage device may determine that the first storage device 104 is overloaded because of high host workload, concurrent garbage collection operations, performance degradation, and/or a workload threshold.

In an implementation, the master storage device may monitor the Input/Output Operations Per Second (IOPS) and bandwidth usage of storage devices 104. If these metrics exceed a predefined threshold on a storage device 104, the master storage device may consider that storage device 104 to be overburdened. The master storage device may also track the number of ongoing garbage collection operations on storage devices 104. If garbage collection activities are frequent and/or prolonged on a storage device 104, the master storage device may consider that storage device 104 to be overburdened. The master storage device may also measure the response times and latency on storage devices 104. If there is significant increase in the response times and latency on a storage device 104, the master storage device may consider that storage device 104 to be overburdened. The master storage device may also monitor specific threshold(s) for workload metrics, and when these thresholds are crossed on a storage device 104, the master storage device may consider that storage device 104 to be overburdened.

When, for example, storage device 104a is identified to be overburdened with host workload and/or simultaneous garbage collection activities, the master storage device may offload the garbage collection workload of storage device 104a to another/second storage device 104. The second storage device 104 may act as an over-provisioning agent, i.e., the over-provisioning space of the second storage device 104 may be used to help with the garbage collection workload of the first storage device. For example, the master storage device may identify storage device 104b as an over-provisioning agent, wherein storage device 104b may provide over-provisioning region 114b to be used for the garbage collection activities on storage device 104a.

The master storage device may select the over-provisioning agent based on workload metrics and/or spare blocks metrics. For example, the master storage device may select the storage device with the least workload to serve as the over-provisioning agent, provided that the selected storage device has the block margins to accomplish garbage collection while also adhering to quality-of-service requirements. The master storage device may select the storage device with the maximum available spare blocks to serve as an ideal candidate for the over-provisioning agent.

The master storage device may also monitor the number of free blocks in a storage device to determine usage on the storage device. If the master storage device determines that the number of free blocks (i.e., a free block count) in the storage device is less than an acceptable threshold, the master storage device may determine that the storage device has high usage and may need over-provisioned blocks which another storage device may support. As such, a storage device which may use the over-provisioned blocks of another storage device may be a storage device with the least number of free blocks or a number of free blocks below a threshold.

The master storage device may maintain an over-provisioning management table capturing metrics for each storage device 104 in the network. The metrics may be, for example, the workload and over-provisioning space on each storage device 104. The master storage device may periodically update the over-provisioning management table based on the current state of the network. Based on the contents of the over-provisioning management table, the master storage device may select a storage device 104 with the least workload and maximum spare blocks as the over-provisioning agent.

In an implementation, controller 108a may determine that the host workload or garbage collection workload for storage device 104a is beyond a predefined threshold and as such controller 108a may determine that storage device 104a is overburdened. To maintain the quality-of-service requirements of storage device 104a or to enable storage device 104a to continue processing host requests with minimal impact, controller 108a may determine that storage device 104a may need assistance from an over-provisioning agent. When controller 108a determines that it needs over-provisioning resources to continue servicing the host workload, controller 108a may indicate the overburdened state to the master storage device for the master storage device to select a suitable over-provisioning agent for storage device 104a. The master storage device may select the storage device with the least amount of workload and sufficient over-provisioning space as a best fit for the over-provisioning agent to help the overburdened storage device 104a.

The master storage device may statically or dynamically select at least one storage device 104 to serve as the over-provisioning agent. When an over-provisioning agent is statically selected, the sole or primary purpose of the over-provisioning agent may be to satisfy the over-provisioning requirements of the other storage devices 104. The over-provisioning agent, or at least a portion of the over-provisioning agent may not participate in capacity obligations. A storage device 104 may be dynamically selected to serve as the over-provisioning agent based on current network conditions and requirements. The dynamically selected over-provisioning agent may shift roles based on load balancing and resource availability. Any storage device 104 on sensing the need for additional over-provisioning resources may use reserved over-provisioning space on a statically or dynamically marked over-provisioning agent. In an example where storage device 104a is overburdened and requires additional over-provisioning resources, the master storage device, for example, storage device 104n may allocate an over-provisioning agent, for example, storage device 104b, based on metrics maintained in the over-provisioning management table. Storage device 104a may use over-provisioning region 114b to move data.

Storage device 104 may perform these processes based on a processor, for example, controller 108 executing software instructions stored by a non-transitory computer-readable medium, such as storage component/memory device 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

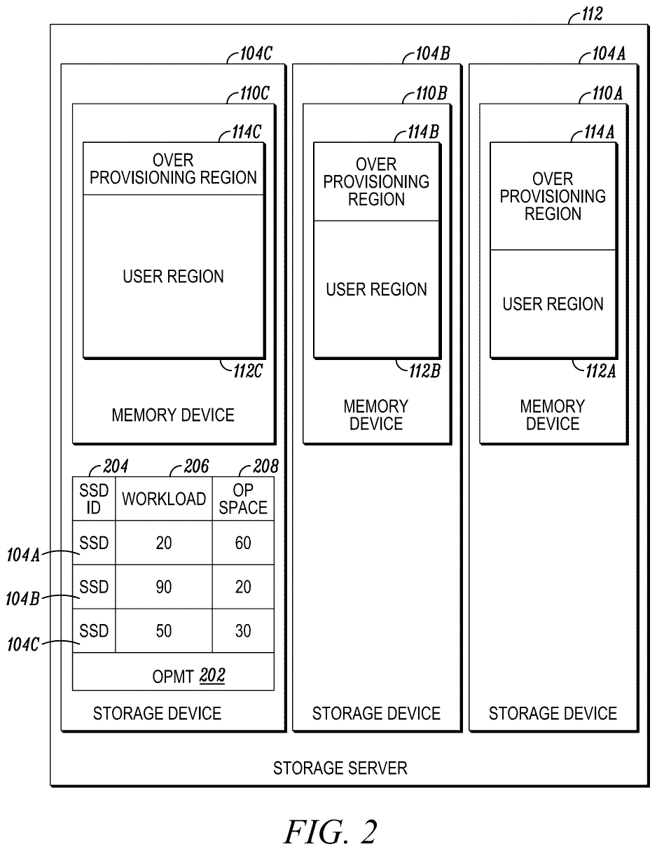

FIG. 2 is a schematic block diagram of an example server that includes multiple storage devices wherein over-provisioning space among peer storage devices is managed in accordance with some implementations. In storage server 112, storage device 104c may serve as a master storage device to drive the data transfer between storage devices 104a and 104b. The master storage device may monitor the storage devices 104a-104c to identify an overloaded storage device. The master storage device may determine that the first storage device 104 is overloaded because of high host workload, concurrent garbage collection operations, performance degradation, and/or a workload threshold.

Master storage device 104c may maintain an over-provisioning management table (OPMT) 202 that may be used to capture metrics for each storage device 104 in the network. An entry in OPMT 202 may include the identifier for a storage device (i.e., SSD ID 204), the workload associated with the storage device (i.e., workload 206), the over-provisioning space (i.e., OP space 208) associated with the storage device. Master storage device 104c may periodically update the OPMT 202 based on the current state of the network. Based on the contents of OPMT 202, the master storage device may select a storage device 104 with the least workload and maximum spare blocks as the over-provisioning agent.

Using the contents of OPMT 202 as an example, master storage device 104c may identify storage device 104b to be overburdened with host workload and/or simultaneous garbage collection activities. Master storage device 104c may offload the garbage collection workload of storage device 104b to storage device 104a, wherein storage device 104a may provide over-provisioning region 114a to be used for the garbage collection activities on storage device 104b. As indicated above FIG. 2 is provided as an example. Other examples may differ from what is described in FIG. 2.

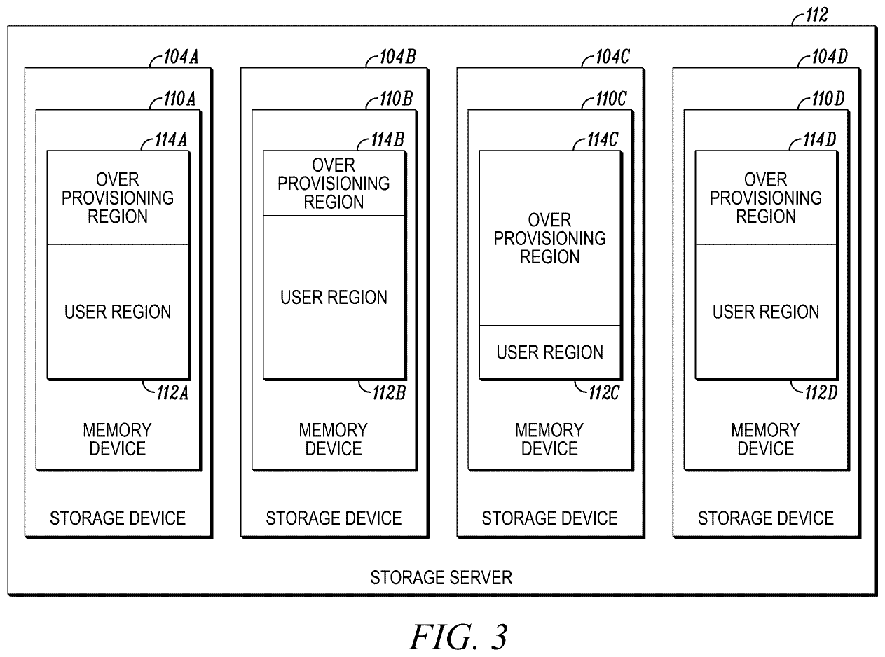

FIG. 3 is another schematic block diagram of an example server that includes multiple storage devices wherein over-provisioning space among peer storage devices is managed in accordance with some implementations. In storage server 112, storage device 104d may serve as a master storage device to drive the data transfer between storage devices 104a-104d. Master storage device 104d may monitor the storage devices 104a-104d to identify an overloaded storage device. Master storage device 104d may statically or dynamically select at least one storage device 104 to serve as the over-provisioning agent. For example, master storage device 104d may select storage device 104c to serve as the over-provisioning agent. When storage device 104c is statically selected to be the over-provisioning agent, a primary purpose of storage device 104c may be to satisfy the over-provisioning requirements of the other storage devices 104a, 104b and 104d. Storage device 104c, or at least a portion of storage device 104c may not participate in capacity obligations. Storage device 104c may be dynamically selected to serve as the over-provisioning agent based on current network conditions and requirements and may shift roles based on load balancing and resource availability. Any storage device 104 on sensing the need for additional over-provisioning resources may use reserved over-provisioning space on a statically or dynamically marked over-provisioning agent. In an example where storage device 104a is overburdened and requires additional over-provisioning resources, master storage device 104d may allocate storage device 104c based on metrics maintained in the OPMT 202. Storage device 104a may use over-provisioning region 114c to move data. As indicated above FIG. 3 is provided as an example. Other examples may differ from what is described in FIG. 3.

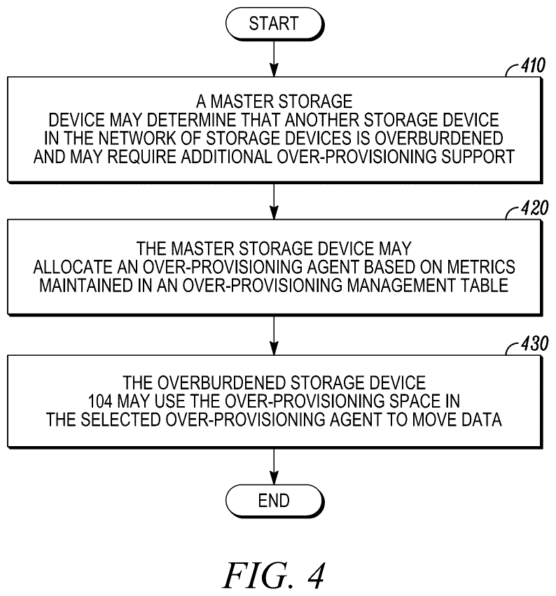

FIG. 4 is an example flow diagram for using one of the storage devices in a network of storage devices as an over-provisioning agent in accordance with some implementations. At 410, a master storage device may determine that another storage device in the network of storage devices is overburdened and may require additional over-provisioning support. At 420, the master storage device may allocate an over-provisioning agent based on metrics maintained in an over-provisioning management table. At 430, the overburdened storage device 104 may use the over-provisioning space in the selected over-provisioning agent to move data. As indicated above FIG. 4 is provided as an example. Other examples may differ from what is described in FIG. 4.

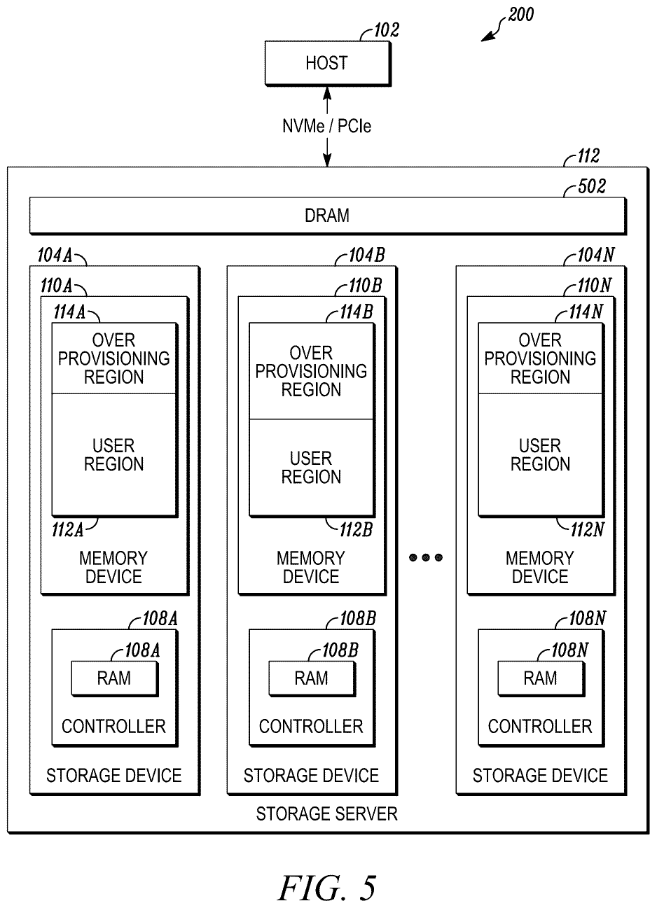

FIG. 5 is a schematic block diagram of an example system including a network of storage devices wherein garbage collection activities are distributed from a first storage device capacity blocks to another storage device capacity blocks in accordance with some implementations. Storage server 112 may include a common random-access memory (RAM), for example, dynamic RAM (DRAM) 502, that may be accessed by storage device 104a-104n. A first storage device 104 may perform garbage collection for a second storage device, such that source data from the first storage device may be stored in destination blocks on another storage device 104. For example, if storage device 104b is an over-provisioning agent and storage device 104a is identified as being overburdened by a master storage device, storage device 104b may perform garbage collection for storage device 104a.

When, for example, controller 108a (i.e., the controller in the overburdened storage device) or a controller in the master storage device determines that storage device 104a is overburdened, controller 108a or the controller on the master storage device or the over-provisioning agent may evaluate the lane traffic between storage devices 104. Controller 108a or the controller on the master storage device or the over-provisioning agent may determine if cross-storage device garbage collections may be triggered based on lane traffic conditions. If cross-storage device garbage collection is triggered based on the lane traffic conditions, the overburdened storage device 104 (for example, storage device 104a) may obtain data from source blocks on storage device 104a and place the data in DRAM 502. The master storage device or any storage device serving as the over-provisioning agent may copy the data in DRAM 502 to destination blocks on another storage device 104 (for example, the data may be copied to destination blocks on any one of storage device 104b-104n). A master storage device or any storage device serving as the over-provisioning agent may oversee the data transfer between the two storage devices 104 via DRAM 502.

In an example where storage device 104b is overseeing the data transfer between two storage devices 104, storage device 104b may write back the valid data on blocks on any one of storage device 104b-104n, relieving storage device 104a from some of the work of garbage collection. Moving data to destination blocks in another storage device may save the writeback time (of valid data) on the first storage device (i.e., storage device 104a) at the cost of increased lane traffic between storage devices 104. This approach may reduce the garbage collection workload on storage device 104a, allowing storage device 104a to better accommodate host workloads while maintaining optimal quality-of-service. As indicated above FIG. 5 is provided as an example. Other examples may differ from what is described in FIG. 5.

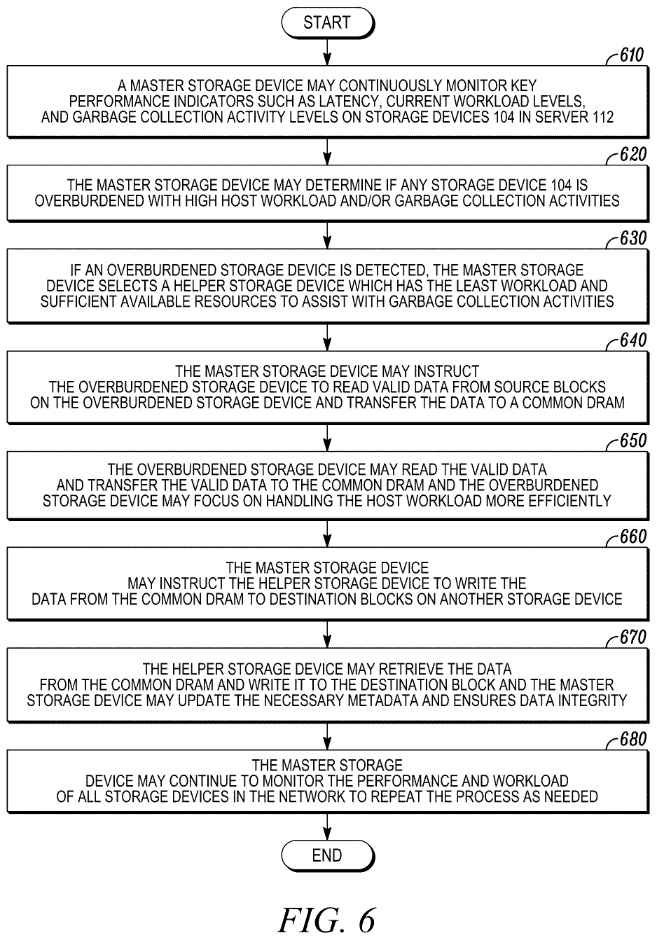

FIG. 6 is an example flow diagram for offloading garbage collection workload from an overburdened storage device to a helper storage device in a network of storage devices in accordance with some implementations. At 610, a master storage device may continuously monitor key performance indicators such as latency, current workload levels, and garbage collection activity levels on storage devices 104 in server 112. At 620, the master storage device may determine if any storage device 104 is overburdened with high host workload and/or garbage collection activities. At 630, if an overburdened storage device is detected, the master storage device selects a helper storage device which has the least workload and sufficient available resources to assist with garbage collection activities. At 640, the master storage device may instruct the overburdened storage device to read valid data from source blocks on the overburdened storage device and transfer the data to a common DRAM.

At 650, the overburdened storage device may read the valid data and transfer the valid data to the common DRAM and the overburdened storage device may focus on handling the host workload more efficiently. At 660, the master storage device may instruct the helper storage device to write the data from the common DRAM to destination blocks on another storage device. At 670, the helper storage device may retrieve the data from the common DRAM and write it to the destination block and the master storage device may update the necessary metadata and ensure data integrity. At 680, the master storage device may continue to monitor the performance and workload of all storage devices in the network to repeat the process as needed. As indicated above FIG. 6 is provided as an example. Other examples may differ from what is described in FIG. 6.

The configuration of storage server 112 may ensure that the network of storage devices operates efficiently, maintaining high performance and reliability by intelligently managing and distributing the garbage collection workload. The configuration of server storage 112 may balance the workload across the network, preventing performance drops due to overburdened storage devices. The configuration of storage server 112 may reduce wear on individual storage devices by distributing garbage collection operations and thus extend the lifespan of the storage devices. The configuration of storage server 112 may also reduce the need for high over-provisioning budgets in individual storage devices, thus lowering the overall costs the components of storage server 112.

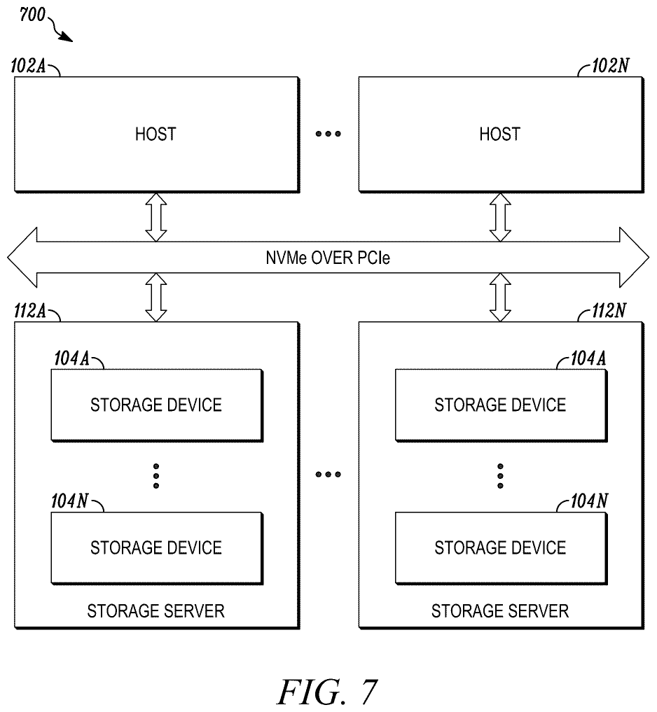

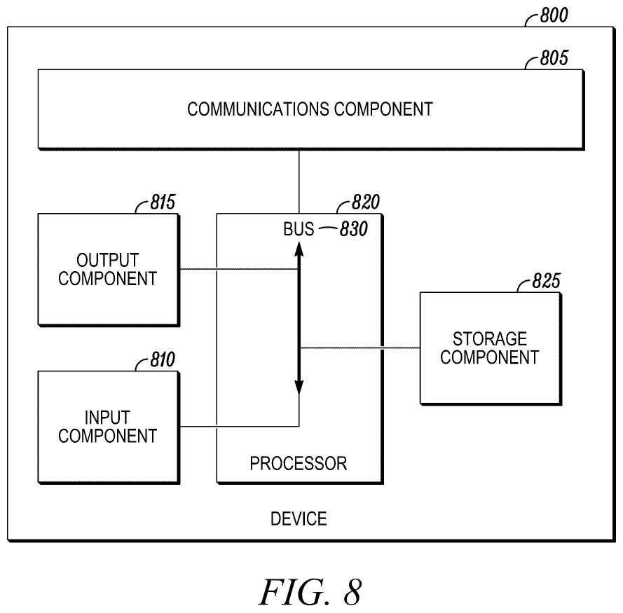

FIG. 7 is a diagram of an example environment in which systems and/or methods described herein are implemented. As shown in FIG. 7, Environment 700 may include hosts 102-102n (referred to herein as host(s) 102), and one or more storage servers 112a-112n (referred to herein as storage server(s) 112). Storage servers 112 may mitigate system performance degradation caused by garbage collection activities on one or more storage devices 104 in a storage server 112. Storage servers 112 may also distribute garbage collection activities from user capacity blocks on a first storage device 104 in a storage server, for example storage server 112a to user capacity blocks on a second storage device 104 in storage server 112a. Hosts 102 and storage servers 112 may communicate via Non-Volatile Memory Express (NVMe) over peripheral component interconnect express (PCI Express or PCIe), SD, or the like.

Devices of Environment 700 may interconnect via wired connections, wireless connections, or a combination of wired and wireless connections. For example, the network in FIG. 7 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of Environment 700 may perform one or more functions described as being performed by another set of devices of Environment 700.

FIG. 8 is a diagram of example components of one or more devices of FIG. 1. In some implementations, host 102 may include one or more devices 800 and/or one or more components of device 800. Device 800 may include, for example, a communications component 805, an input component 810, an output component 815, a processor 820, a storage component 825, and a bus 830. Bus 830 may include components that enable communication among multiple components of device 800, wherein components of device 800 may be coupled to be in communication with other components of device 800 via bus 830.

Input component 810 may include components that permit device 800 to receive information via user input (e.g., keypad, a keyboard, a mouse, a pointing device, and a network/data connection port, or the like), and/or components that permit device 800 to determine the location or other sensor information (e.g., an accelerometer, a gyroscope, an actuator, another type of positional or environmental sensor). Output component 815 may include components that provide output information from device 800 (e.g., a speaker, display screen, and network/data connection port, or the like). Input component 810 and output component 815 may also be coupled to be in communication with processor 820.

Processor 820 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 820 may include one or more processors capable of being programmed to perform a function. Processor 820 may be implemented in hardware, firmware, and/or a combination of hardware and software.

Storage component 825 may include one or more memory devices, such as random-access memory (RAM 106), read-only memory (ROM), and/or another type of dynamic or static storage device (e.g., a flash memory, a magnetic memory, and/or optical memory) that stores information and/or instructions for use by processor 820. A memory device may include memory space within a single physical storage device or memory space spread across multiple physical storage devices. Storage component 825 may also store information and/or software related to the operation and use of device 800. For example, storage component 825 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 805 may include a transceiver-like component that enables device 800 to communicate with other devices, such as via a wired connection, a wireless connection, or a combination of wired and wireless connections. The communications component 805 may permit device 800 to receive information from another device and/or provide information to another device. For example, communications component 805 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 805 may also include one or more broadband and/or narrowband transceivers and/or other similar types of wireless transceiver configurable to communicate via a wireless network for infrastructure communications. Communications component 805 may also include one or more local area network or personal area network transceivers, such as a Wi-Fi transceiver or a Bluetooth transceiver.

Device 800 may perform one or more processes described herein. For example, device 800 may perform these processes based on processor 820 executing software instructions stored by a non-transitory computer-readable medium, such as storage component 825. As used herein, the term “computer-readable medium” refers to a non-transitory memory device. Software instructions may be read into storage component 825 from another computer-readable medium or from another device via communications component 805. When executed, software instructions stored in storage component 825 may cause processor 820 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises. . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage server to mitigate system performance degradation caused by garbage collection activities on one or more storage devices in the storage server, the storage server comprises
multiple storage devices, each of which executes garbage collection activities to optimize memory usage; and
a master storage device to monitor storage devices on the storage server, identify an overburdened storage device and offload a garbage collection workload of the overburdened storage device to a second storage device,
wherein the second storage device is an over-provisioning agent for the overburdened storage device and an over-provisioning region on the second storage device is used for the garbage collection workload of the overburdened storage device.

2. The storage device of claim 1, wherein the master storage device determines that a first storage device is overburdened based on at least one of a high host workload, concurrent garbage collection operations, performance degradation, and a workload threshold.

3. The storage device of claim 1, wherein the master storage device monitors at least one of Input/Output Operations Per Second (IOPS), bandwidth usage, and a number of free blocks of the storage devices and if the IOPS and bandwidth of a first storage device exceed a predefined threshold or if the number of free blocks is less than a threshold, the master storage device determines that the first storage device is overburdened.

4. The storage device of claim 1, wherein the master storage device tracks a number of ongoing garbage collection operations on the storage devices and if the garbage collection activities on a first storage device is at least one of frequent and prolonged, the master storage device determines that a first storage device is overburdened.

5. The storage device of claim 1, wherein the master storage device measures response times and latency on the storage devices and if there is an increased response time and latency on a first storage device, the master storage device determines that the first storage device is overburdened.

6. The storage device of claim 1, wherein the master storage device monitors a threshold for workload metrics on the storage device and if the threshold is crossed on a first storage device, the master storage device determines that the first storage device is overburdened.

7. The storage device of claim 1, wherein the master storage device maintains an over-provisioning management table that includes at least one of workload metrics and over-provisioning space metrics of the storage devices and selects the over-provisioning agent based on at least one of the workload metrics and spare blocks metrics.

8. The storage device of claim 1, wherein the master storage device identifies the overburdened storage device based on an indication from a controller on the overburdened storage device, wherein the controller generates the indication when one of a host workload and a garbage collection workload on the overburdened storage device is beyond a predefined threshold.

9. The storage device of claim 1, wherein a storage device having a least amount of workload and sufficient over-provisioning space is selected by the master storage device as the over-provisioning agent.

10. The storage device of claim 1, wherein the master storage device one of (i) statically selects the over-provisioning agent wherein a primary purpose of a statically selected over-provisioning agent is to satisfy over-provisioning requirements of other storage devices, and (ii) dynamically selects the over-provisioning agent based on current network conditions and requirements, wherein a dynamically selected over-provisioning agent shifts roles based on load balancing and resource availability.

11. A method in a storage server to mitigate system performance degradation caused by garbage collection activities on one or more storage devices in the storage server, the storage server comprises a master storage device to execute the method comprising:
monitoring storage devices on the storage server;
identifying one of an overburdened storage device and a storage device where a free block count is less than a threshold; and
offloading a garbage collection workload of the overburdened storage device to a second storage device,
wherein the second storage device is an over-provisioning agent for the overburdened storage device and an over-provisioning region on the second storage device is used for the garbage collection workload of the overburdened storage device.

12. The method of claim 11, further comprising determining that a first storage device is overburdened based on at least one of a high host workload, concurrent garbage collection operations, performance degradation, and a workload threshold.

13. The method of claim 11, further comprising at least one of:
monitoring Input/Output Operations Per Second (IOPS) and bandwidth usage of the storage devices and if the IOPS and bandwidth of a first storage device exceed a predefined threshold, determining that first storage device is overburdened,
tracking a number of ongoing garbage collection operations on the storage devices and if garbage collection activities on the first storage device is at least one of frequent and prolonged, determining that first storage device is overburdened,
measuring response times and latency on the storage devices and if there is an increased response time and latency on the first storage device, determining that first storage device is overburdened, and
monitoring a threshold for workload metrics on the storage device and if the threshold is crossed on the first storage device, determining that first storage device is overburdened.

14. The method of claim 11, further comprising maintaining an over-provisioning management table that includes at least one of workload metrics and over-provisioning space metrics of the storage devices and selecting the over-provisioning agent based on at least one of the workload metrics and spare blocks metrics.

15. The method of claim 11, further comprising identifying the overburdened storage device based on an indication from a controller on the overburdened storage device, wherein the controller generates the indication when one of a host workload and a garbage collection workload on the overburdened storage device is beyond a predefined threshold.

16. The method of claim 11, further comprising selecting a storage device having a least amount of workload and sufficient over-provisioning space as the over-provisioning agent.

17. The method of claim 11, further comprising one of (i) statically selecting the over-provisioning agent wherein a primary purpose of a statically selected over-provisioning agent is to satisfy over-provisioning requirements of other storage devices, and (ii) dynamically selecting the over-provisioning agent based on current network conditions and requirements, wherein a dynamically selected over-provisioning agent shifts roles based on load balancing and resource availability.

18. A storage server to distribute garbage collection activities from user capacity blocks on a first storage device in a network of storage devices to user capacity blocks on a second storage device in the network, the storage server comprises:
multiple storage devices, each of which executes garbage collection activities to optimize memory usage;
a common volatile memory that is accessed by storage devices in the network; and
a master storage device to monitor the storage devices, identify a first storage device as an overburdened storage device; select a second storage device is an over-provisioning agent, and trigger cross-storage device garbage collections,
wherein after cross-storage device garbage collections are triggered, the first storage device obtains data from source blocks on the first storage device and places the data in the common volatile memory and the second storage device copies the data from the common volatile memory to destination blocks on another storage device.

19. The storage device of claim 18, the master storage device evaluates lane traffic between the storage devices and triggers cross-storage device garbage collections based on lane traffic conditions.

20. The storage device of claim 18, the master storage device oversees data transfer between the first storage device and the common volatile memory and data transfers between the common volatile memory and the second storage device.
